(19) United States
(12) Patent Application Publication
(10) Pub. No.: US 2025/0024869 A1
(43) Pub. Date: Jan. 23, 2025

(54) NOVEL ENHANCED NUTS AND OTHER FOODSTUFFS AND CANNABINOID BLENDS AND FORMULATIONS

(71) Applicant: NCE LLC, Santa Ana, CA (US)

(72) Inventors: Kaveh Newmen, Santa Ana, CA (US); Nick Gluck, Laguna Beach, CA (US); Gene Galyuk, Valley Village, CA (US)

(21) Appl. No.: 18/775,165

(22) Filed: Jul. 17, 2024

Related U.S. Application Data
(60) Provisional application No. 63/514,162, filed on Jul. 18, 2023.

(51) Int. Cl. A23L 25/00; A21D 2/26; A21D 2/36; A23L 25/10; A23L 29/00

(52) U.S. Cl. CPC A23L 25/25; A21D 2/262; A21D 2/364; A23L 25/10; A23L 25/30; A23L 29/04; A23L 29/045

(57) ABSTRACT

Nuts and related foodstuffs are contacted with/by cannabinoids, including hemp derived Delta8/9 via several different mechanisms, whereby the cannabinoids are attached, infused, coated, adhesed, adhered, and otherwise attached to said nuts and related foodstuffs, for ingestion by humans.

### CROSS-REFERENCE TO RELATED APPLICATIONS

The present application claims priority to U.S. Provisional Application No. 63/514,162, filed Jul. 18, 2023, the contents of which are incorporated herein by reference in their entirety.

### BACKGROUND OF THE INVENTIONS

The introduction of novel enhanced nuts and other foodstuffs and cannabinoid blends and formulations would be highly influential in both the Cannabis and wholesale markets. The unique coating applied to nuts and other foodstuffs will allow for a breakthrough in a variety of markets. These developments have the potential to upend the current market for items containing Cannabis and appeal to a larger spectrum of customers.

Traditionally, digestible Cannabis products have primarily consisted of sweet-flavored options such as gummies, cookies, brownies, and soft drinks, which are typically favored by the recreational Cannabis community. However, there is a significant opportunity for a paradigm shift by introducing savory Cannabis-infused products. By offering a savory flavor profile, this new product has the potential to tap into a market segment that has been largely underserved. This differentiation in flavor can attract not only recreational users but also individuals seeking a healthier alternative to sugary Cannabis products.

Moreover, this novel product has the potential to make waves in higher-quality wholesale markets, such as WHOLE FOODS or TRADER JOES. These stores are known for their emphasis on organic, natural, and healthy food options. By incorporating CBD oil, which has gained recognition for its potential wellness benefits, into already popular products like nuts, chips, or dried fruits/vegetables, a revolutionary consumer product can be created. This combination aligns with the health-conscious preferences of the target demographic, offering a unique value proposition in the wholesale market.

The introduction of these innovative, savory Cannabis-infused products not only expands the choices available to Cannabis consumers but also presents an opportunity to reach a wider audience. By capitalizing on the growing demand for healthier, natural options and leveraging the potential benefits of CBD oil, this product has the potential to disrupt both the Cannabis and wholesale markets, ultimately driving significant sales and market share.

### FIELD OF THE INVENTIONS

The 2018 farm bill legalized industrial hemp and established the Domestic Hemp Production Program, but it also created confusion around the legality of CBD and other cannabinoids for internal and medical uses. The current edibles market is at least 30% of a market of $38B, or projected to be in excess of $10B during fiscal 2024-25. The 2023 farm bill is expected to address several issues related to hemp and cannabinoids. It may increase the allowable THC amount in hemp from 0.3% to 1% and allow higher THC amounts in “work-in-progress” products.

It may also remove the requirement for DEA lab testing and the ban on obtaining a hemp license for those with drug convictions. Furthermore, the bill may seek to clarify the legal status of hemp-derived cannabinoid products. Pundits speculate that a roadmap for legalization can thus be re-set, and allow consumer goods to be proffered having both regulated and safe levels of medicinal and recreational CBD/THC based Cannabinoids, with visibility and transparency allowing both consumers and those in the chains of distribution to better manage the use of these issues. Several congressional bills have been proposed to address these issues, including HR 841 and S. 1698, which deal with the allowance of CBD and other cannabinoids in dietary supplements and food.

Other proposed laws include H.R. 6134, which seeks to establish safety standards and labeling requirements for cannabinoid products, and H.R. 6645, which aims to tackle the issue of synthetic derivatives. The impact of these potential changes on the hemp industry will become clear once the 2023 farm bill is finalized. According to the teachings of the present inventions, benefits of such progressive legislative change could impact the way that such moieties are made available and safely used.

### OBJECTS AND SUMMARY OF THE INVENTIONS

Briefly stated, nuts and related foodstuffs are contacted with/by cannabinoids, including hemp derived Delta8/9 via several different mechanisms, whereby the cannabinoids are attached, infused into, coated upon, adhesed, adhered, and otherwise attached to said nuts and related foodstuffs, for ingestion by humans.

According to embodiments, there are provides processes to treat/coat/infuse for example, nuts with Cannabis-based and derived moieties, comprising at least several mechanisms such as providing a Cannabis source such as solventless hashish (see for example US Letters Patent umber 9,732,009), which provides relatively homogeneous particles which stick to nuts under specified reaction conditions, combining the same with at least another or two other means for permanently adhering said particles to nuts; whereby the nuts are pleasing to ingest for humans, with or without other enhancers added.

According to embodiments, there are disclosed the nuts being any known naturally occurring nuts, such as shelled kana pecan halves, for example, at a weight of 1.5 lbs.

According to embodiments, there is disclosed a process of claims herein, the Cannabis-based and derived moiety being a least one of 2.5 and 3.5 grams of solventless hashish and the like compounds, including Delta8/THC derived products, synthetic variations.

According to embodiments, there is disclosed any processes of claims herein, wherein at least one egg is included, along with any bakery confectionary supplies that are helpful.

According to embodiments, there is disclosed processes of claims 1-10 with 2 tablespoons of vanilla extract, cinnamon or the like confectionaries with ranges of dosages.

According to embodiments, there is disclosed, the process with any other nuts or natural products.

According to embodiments, The processes disclosed with anything edible by humans having a taste profile as desiderata.

According to embodiments, Products by the processes herein being pecans with cinnamon, sea salt and a sugar based ingredient, or almonds, walnuts or any related foodstuff which is effectively coated.

According to embodiments, a dry-mix version of the admixtures offered herein for consideration capable of being packaged and shipped.

According to embodiments, method for preparing a composition that comprises a plurality of coated nuts, the method comprising the steps of placing a plurality of nuts in a container, wherein the container comprises a bottom and a retaining wall or sides, wherein the plurality of nuts in the container is capable of receiving and supporting an added cannabinoid extract or resin and the plurality of edible nuts is capable of substantially preventing contact of the cannabinoid extract or resin with the bottom of the container and is also capable of substantially preventing contact of the cannabinoid extract or resin with the retaining wall or sides, placing a cannabinoid extract or resin on top of the plurality of edible particles, wherein the cannabinoid extract or resin does not substantially contact the bottom of the container, and does not substantially contact the retaining wall or sides of the container, and mixing until the cannabinoid extract or resin coats the edible particles to produce a coating, resulting in a composition of homogeneously coated edible particles, and wherein the homogeneously coated edible particles possess a homogeneity.

According to embodiments at least the method of Claims 1-39, further comprising the step of initiating device mediated mixing of the cannabinoid extract or resin with the plurality of edible particles using a mixer, wherein the mixing generates an admixture, suspension or slurry.

According to embodiment, steps above wherein at the step where the cannabinoid extract or resin is placed on top of the plurality of edible particles, less than 10% of the extract or resin at this step contacts the bottom of the container, retaining wall, or sides.

According to embodiments, the method of claims herein, wherein the homogeneously coated particles have a homogeneity, and where the homogeneity is definable by the range of values for specific surface area, in a given sample of at least 1000 coated particles.

According to embodiments, there are disclosed processes for infusion of at least a cannabinoid (derived from Delta 9 for example, under the FARM BILL infra), further comprising, in combination, heating nuts or related foodstuffs to open pores of said items; providing a homogenized admixture of CBD/hemp-derived cannabinoids, causing the homogenized admixture to enter into at least some of said pores, curing, or causing the at least some of said pores to close.

According to embodiments, there are disclosed products by any processes herein, wherein the distribution per nut, or related foodstuff is controlled or monitored by unit dose.

According to embodiments there are disclosed, chip-sets, motherboards and means-for executing application specific software, optionally including AI, to monitor processes herein.

According to embodiments, there are disclosed Data sets, derived from anything herein disclosed, pertaining to the coating, infusion and gram weight of the cannabinoids, and related moieties herein.

According to embodiments there is provided a kit, comprising, in combination, at least a set of nuts, said nuts being at least one of coated with, infused with, or otherwise combined with at least a cannabinoid blend, including Delta 8/9 hemp derived oil, distillate or other admixture; and another package/container or other means-for-holding a larger bag of trail mix.

According to embodiments, disclosed is a nut butter selected from the group of peanut, almond, walnut, pecan and the like infused/coated/covered or otherwise cannabinoid-including powder/admixture/solution.

According to embodiments, there is provided, combined cannabinoid-nut butter set combined with other foodstuffs.

According to embodiments there is provided, processes for heating of nuts with a Cannabis-based solvent to provide a resin/admixture/paste to be applied to other foodstuffs.

### DETAILED DESCRIPTION OF PREFERRED EMBODIMENTS

The disclosure relates to methods for preparing, novel enhanced, for example, nut coatings with Cannabis extracts, powders, blends of extracted cannabinoids and said powders, combinations of various blends with emulsifiers, and compositions made by the methods for delivery of said subject moieties to humans, for example.

The present inventors have discovered how to coat for example nuts with solventless hash and is so doing can make cinnamon pecans, walnuts and other nut and related foodstuffs varieties with a straight forward recipe and approach, disclosed herein and constituting as such progress in the science and useful art worthy of United States Letters Patents, inter alia.

Particles taking the form of a powder can be used as a matrix for delivering compositions such as nutrients, food additives, flavors, fragrances, and medicines, where the compositions that are delivered reside in a coating on the particle. Various matrices can be coated, and these include sugar granules, small salt crystals, pellets of dried yeast, hard candies, and so on. Coated particles can be further processed into forms such as granules, tablets, or by applying additional coatings to create a multiply coated particle.

Techniques for coating particles include spraying, such as spraying a solution or spraying a molten liquid, fluidized bed coating, and polymer coating (see, e.g., Teresk et al (2016) KONA Powder and Particle Journal. DOI: 10.14356). Once manufactured, coated particles can be characterized by particle size analysis, scanning electron microscopy, or by measuring specific surface area ([total surface area]/[unit of mass]) (Rawle A (2002) Adv. Colour Science Technol. 5:112). Examples of coated particles and methods for preparation are as follows. Particles of seasoning, flavoring, or protein, can be suspended in hot swirling air, and then sprayed with a coating of edible gum, wax, or resin (see, U.S. Pat. No. 3,949,096 of Johnson et al). Particles (0.015 mm) of cornstarch can be coated with a dye and then coated with hydroxypropylcellulose, using a fluidized bed coater (see, e.g., Watano et al (204) Powder Technology. 141:172176). To give another example, a chewable medicated tablet can be made from particles having ibuprofen and starch center, then coated with hydroxyethyl cellulose (see, U.S. Pat. No. 5,215,755 of Roche et al).

The present disclosure addresses the need for consumables taking the form of particles coated with cannabinoids. These compositions include nut-centric coatings, coverings, dips and spreads or covering appliances and renderings, as well as dry instant mixes for making these formulations scalable etc.

Heretofore unprecedented is the straight forward recipe and knowhow to make FOR EXAMPLE, CANNABIS-RELATED (as defined herein being anything from Delta 8/the to CBD extracted, derived or otherwise having chemical identity with Cannabis-derivatives in any way shape form, irrespective of cultivar/strain identity and ostensive legal status) varieties of nuts, related foodstuffs and processes flowing from said methodology for products by the process like cinnamon pecans and walnuts etc. . . . with Cannabis coated thereupon. 9. As referred to and used herein, including the appended claims, the singular forms of words such as “a,” “an,” and “the” include their corresponding plural references unless the context clearly dictates otherwise. All references cited herein are incorporated by reference to the same extent as if each individual patent, and published patent application, as well as figures, drawings, sequence listings, compact discs, and the like, was specifically and individually indicated to be incorporated by reference.

The disclosure relates to methods for preparing, novel enhanced, for example, nut coatings with Cannabis extracts, powders, blends of extracted cannabinoids and said powders, combinations of various blends with emulsifiers, and compositions made by the methods for delivery of said subject moieties to humans, for example.

The present inventors have discovered how to coat for example nuts with solventless hash and is so doing can make cinnamon pecans, walnuts and other nut and related foodstuffs varieties with a straight forward recipe and approach, disclosed herein and constituting as such progress in the science and useful art worthy of United States Letters Patents, inter alia.

Particles taking the form of a powder can be used as a matrix for delivering compositions such as nutrients, food additives, flavors, fragrances, and medicines, where the compositions that are delivered reside in a coating on the particle. Various matrices can be coated, and these include sugar granules, small salt crystals, pellets of dried yeast, hard candies, and so on. Coated particles can be further processed into forms such as granules, tablets, or by applying additional coatings to create a multiply coated particle.

Techniques for coating particles include spraying, such as spraying a solution or spraying a molten liquid, fluidized bed coating, and polymer coating (see, e.g., Teresk et al (2016) KONA Powder and Particle Journal. DOI: 10.14356). Once manufactured, coated particles can be characterized by particle size analysis, scanning electron microscopy, or by measuring specific surface area ([total surface area]/[unit of mass]) (Rawle A (2002) Adv. Colour Science Technol. 5:112). Examples of coated particles and methods for preparation are as follows. Particles of seasoning, flavoring, or protein, can be suspended in hot swirling air, and then sprayed with a coating of edible gum, wax, or resin (see, U.S. Pat. No. 3,949,096 of Johnson et al). Particles (0.015 mm) of cornstarch can be coated with a dye and then coated with hydroxypropylcellulose, using a fluidized bed coater (see, e.g., Watano et al (204) Powder Technology. 141:172176). To give another example, a chewable medicated tablet can be made from particles having ibuprofen and starch center, then coated with hydroxyethyl cellulose (see, U.S. Pat. No. 5,215,755 of Roche et al).

The present disclosure addresses the need for consumables taking the form of particles coated with cannabinoids. These compositions include nut-centric coatings, coverings, dips and spreads or covering appliances and renderings, as well as dry instant mixes for making these formulations scalable etc.

Heretofore unprecedented is the straight forward recipe and knowhow to make FOR EXAMPLE, CANNABIS-RELATED (as defined herein being anything from Delta 8/the to CBD extracted, derived or otherwise having chemical identity with Cannabis-derivatives in any way shape form, irrespective of cultivar/strain identity and ostensive legal status) varieties of nuts, related foodstuffs and processes flowing from said methodology for products by the process like cinnamon pecans and walnuts etc. . . . with Cannabis coated thereupon. 9. As referred to and used herein, including the appended claims, the singular forms of words such as “a,” “an,” and “the” include their corresponding plural references unless the context clearly dictates otherwise. All references cited herein are incorporated by reference to the same extent as if each individual patent, and published patent application, as well as figures, drawings, sequence listings, compact discs, and the like, was specifically and individually indicated to be incorporated by reference.

### Cannabinoids

The present disclosure provides extracts, oils, slurries, suspensions, cooled viscous compositions, warmed viscous compositions, compositions comprising purified compounds optionally with one or more solvents, and the like, that comprise one or more of the following compounds: cannabigerol; cannabichromene; cannabitriol; cannabidiol; cannabicyclol; cannabielsoin, cannabinodiol; cannabinol; delta8-tetrahydrocannabinol; delta8-tetrahydrocannabinol; cannabichromanone; cannabicoumaronone; cannabicitran; 10-oxo-delta6a10a-tetrahydrocannabinol; delta9-tetrahydrocannabivarin, cannabiglendol; delta7-isotetrahydrocannabinol; delta9-tetrahydrocannabinolic acid A and B; CBLVA;
CBV; CBDV; CBEVA-B; CBCVA; CBDA; delta9-THCVA; CBDVA; CBGVA; divarinolic acid; quercetin; kaemferol; dihydrokaempferol; dihydroquercetin; cannflavin B; isovitexin; apigenin; naringenin; eriodictyol; luteolin; orientin; cytisoside; vitexin; canniprene; 3,4′-dihydroxy-5-methoxy bibenzyl; dihydroresveratrol; 3,4′dihydroxy-5,3′-dimethoxy-5′-isoprenyl; Cannabistilbene 1; Cannabistilbene 11a; Cannabistilbene 11b; cannithrene 1; cannithrene 2; Cannabispirone; iso-Cannabispirone; Cannabispirenon-A; Cannabispirenone-B; Cannabispiradienone; alpha-Cannabispiranol; beta-Cannabispiranol; acetyl-Cannabispirol; 7-hydroxy-5-methoxyindan-I-spiro-cyclohexane; 5-hydroxy-7-methoxyindan-1-spiro cyclohexane; myristic acid, palmitic acid, oleic acid, stearic acid, linoleic acid, linolenic acid, arachidic acid, eicosenoic acid, behenic acid, lignoceric acid, 5,7-dihydroxyindan-1-cyclohexane; Cannabispiradienone; 3,4′-dihydroxy-5-methoxybibenzyl; canniprene; Cannabispirone; cannithrene I; cannithrene 2; alpha-Cannabispiranol; acetyl-Cannabispirol; vomifoliol; dihydrovomifoliol; beta-ionone; dihydroactinidiolide; palustrine; palustridine; plus-Cannabisativine; anhydroCannabisativine; dihydroperiphylline; Cannabisin-A; Cannabisin-B; Cannabisin-C; Cannabisin-D; grossamide; Cannabisin-E; Cannabisin-F; Cannabisin-G; and so on See, e.g., Flores-Sanchez and Verpoorte (2008) Secondary metabolism in Cannabis in Phytochem. Rev. DOI 10.1007/11101-008-9094-4.

TERPENES may be optionally included or inherent in said Cannabis-derived products. Artisans are familiar with the following US Letters Patents each expressly incorporated by reference as if fully set for the herein, defining the state of the art: U.S. Pat. Nos. 11,285,117; 10,821,089; 10,774,288; 10,596, 486; 10,588,869; 10,507,407; 10,265,292; 10,035,081; 9,732,009; 9,962,340; and all other US references referred to herein, including by IDS.

The founder of terpene chemistry is Otto Wallach who received the Nobel Prize in 1910 (Christmann (2010) Angew Chem. Int. Ed. Engl. 49:9580-9586). The terpenes are biosynthesized from units of isoprene, which can be linked to form linear chains or rings. In increasing length, the terpenes include hemiterpenes (single isoprenoid unit), monoterpenes (two units), sesquiterpenes (three units), diterpenes (four units), sesterterpenes (five units), triterpenes (six units), and so on. Non-aromatic terpenes include vitamin A, vitamin K, and the taxanes. The taxanes (diterpenes), such as paclitaxel, are used for treating cancer (Heinig and Jennewein (2009) African. J Biotech. 8:1370-1385). Terpenes in Cannabis have been described. See, Flores-Sanchez and Verpoorte (2008) Phytochem. Rev. 7:615639, and US2015/0080265 of Elzinga and Raber and US2015/0152018 of Raberand Elzinga, each of which is incorporated herein in its entirety.

The present disclosure provides extracts, oils, slurries, suspensions, cooled viscous compositions, warmed viscous compositions, pure compositions, compositions comprising purified compounds, compositions consisting of purified compounds optionally with one or more solvents, and combinations of pure compounds, of the following: Hemiterpenes: Examples of hemiterpenes that do not necessarily have an odor, are 2-methyl-1,3-butadiene, hemialboside, and hymenoside; Monoterpenes: pinene; alpha-pinene, beta-pinene, cis-pinane, trans-pinane, cis-pinanol, trans-pinanol (Erman and Kane (2008) Chem. Biodivers. 5:910-919), limonene; linalool; myrcene; eucalyptol; alpha-phellandrene; beta-phellandrene; alpha-ocimene; beta-ocimene, cis-ocimene, ocimene, delta-3-carene; fenchol; sabinene, borneol, isoborneol, camphene, camphor, phellandrene, alpha-phellandrene, alpha-terpinene, geraniol, linalool, nerol, menthol, myrcene, terpinolene, alpha-terpinolene, beta-terpinolene, gamma-terpinolene, delta-terpinolene, alpha-terpineol, trans-2-pinanol, Sesquiterpenes: caryophyllene; beta-caryophyllene, caryophyllene oxide, humulene, alpha-humulene, alpha-bisabolene; beta-bisabolene; santalol; selinene; nerolidol, bisabolol; alpha-cedrene, beta-cedrene, beta-eudesmol, eudesm-7(11)-en-4-ol, selina-3,7 (11)-diene, guaiol, valencene, alpha-guaiene, beta-guaiene, delta-guaiene, guaiene, farnesene, alpha-farnesene, beta-farnesene, elemene, alpha-elemene, beta-elemene, gamma-elemene, delta-elemene, germacrene, germacrene A, germacrene B, germacrene C, germacrene D, germacrene E. Diterpenes: oridonin, Triterpenes: ursolic acid; oleanolic acid; [0012] “1.5 ene”: guaia-1(10),11-diene can be characterized as a 1.5 ene. Guaia-1 (10),11-diene is halfway between a monoterpene and diterpene, in terms of how many isoprenoid units are present. Monoterpene is CIoH16, and diterpene is C2oH32. Guaia-1(10), 11-diene is CisH24. Isoprene is C§ Hs (two double bonds).

The present disclosure provides compounds in hops (Humulus lupulus). These compounds include myrcene, alpha-humulene, and beta-caryophyllene, which are in hop essential oils. Other hop compounds are bitter acids, such as alpha-acid and beta-acid (humulone and lupulone), which are prenylated polyketide derivatives. Prenylated flavonoids are also in hops, and these include xanthohumol, desmethylxanthohumol, isoxanthohumol, 8-prenylnaringenin, and 6prenylnaringenin (Wang et al (2008) Plant Physiol. 148:12541266; Nagel et al (2008) Plant Cell. 20:186200).

### Extracting Compounds

US Letters Patents U.S. Pat. Nos. 10,035,081; 10,507,407 and all cases related to the same are expressly incorporated by reference as if fully set forth herein.

Extracting compounds from natural products can use methods and reagents, for example, as described by US2015/0152018 of Raber and Elzinga, which is incorporated herein by Reducing or eliminating risk of explosions.

The method reduces explosion risk by one or more of: (a) Limiting the plurality of edible particles to a mass of 10 kg or less, 5 kg or less, 2 kg or less, 1 kg or less, 750 grams or less, 500 grams or less, 250 grams or less, 100 grams or less, 50 grams or less, and so on; (b) Providing a ventilator that removes any dust by way of ventilation; (c) Limiting or not using any compounds that generate hydroxymethylfurfural; (d) Limiting or eliminating flammable solvents; and (e) Limiting or eliminating use of elevated temperatures that can ignite a flammable solvent. To provide background information, dust may be defined as particles of 500 micrometers or less that are suspended in air. As surface area increases, the exposure of the dust matrix to atmospheric oxygen increases, with a resulting increase in risk for combustion when a spark is present. Granulated sugar is 570635 micrometers in diameter, and powdered sugar is about 600 micrometers in diameter. Heat can induce sucrose to decompose and form a volatile chemical (hydroxymethylfurfural) which easily ignites (see, Tinnes and M (December 2010) Sugar an unusual explosive. ChemMatters; ScienceLab.com. Material Safety Data Sheet. 5-Hydroxy-2-Furaldehyde. Sciencelab.com, Inc., Houston, TX).

### Examples

See the instant applications and exemplary recipes and HPLC chromatographs of the instant inventions, as known to those skilled in the art.

### Physical Characteristics of Compositions Subjected to Homogenization

In some circumstances, a cannabinoid mass that has disintegrated into small pellets may resist homogenization. When a large ball of cannabinoids has its viscosity reduced too low it has been found to string out into small 1-3 mm spheres and it resists blending down further. Tests with refreezing have shown that even if the powder is refreezed, the small spheres of cannabinoids resist homogenization.

### Loading Chemicals on Particles and Powders

Loading as high as 15% can be attained. In detail, this means that 15 g of Cannabis extract can be coated onto 85 g powder to yield 100 gram of end product. This value was determined using confectioners' sugar which has a particle size of approximately 10-50 um. As this is a coating mechanism, higher loadings can be possible with smaller particle sizes as there is more surface area available.

It is to be understood that the present invention is not to be limited by compositions, reagents, methods, diagnostics, laboratory data, and the like, of the present disclosure, and that the present invention is not be limited by any preferred embodiments that are disclosed herein.

What is claimed is:

1. A process to coat nuts with Cannabis-based and derived moieties, which comprises, in combination:
providing a Cannabis source processed into homogeneous particles which are at least one of disposed in disposed and about nuts, including a substituent resolutory moiety complex of a dried extract;
combining the same with at least another adhering/adhesing/attaching material for binding said particles to nuts; whereby the nuts are pleasing to ingest for humans, along with optional enhancers added or chimeric with the instant admixture.

2. Products by the process of claim 1, wherein the dried extract contains one or more cannabinoids, and wherein the dried extract contains one or more of, chlorophyll a, linoleic acid, oleic acid, a wax, behenyl arachidate, cannaflavin, and canflavin A.

3. Products by the process of claim 2, further comprising at least one of an oil, a slurry, a terpene, an essential oil, a plurality of terpenes, a powder, a vaping solution, an aerosol, a vape juice, an e-liquid, an e-juice, an oral formulation, a suppository, a sublingual formulation, or a dermal formulation.

4. A formulation that comprises a composition prepared by the process of claim 3, wherein the formulation also includes one or more terpenes, and wherein the one or more terpenes are selected from alpha-bisabolol, boreol, camphene, camphor, delta-3-carene, caryophyllene oxide, alpha-cedreen, beta-endesmol, fenchol, geraniol, guarol, alpha-humulene, isobomeol, linalool, menthol, nerol, cis-ocimene, traos-ocimene, alpha-phellandrone, alpha-pinene, beta-pinene, sabinene, alpha-terpinene, alpha-terpineol, terpinolene, alpha-guaiene, clemene, farnesene, germacene B. guaia-1 (10), I 1-diene, trans-2-pinanol, selina-3,7(11)-diene, eudesm-7(11)-en-4-ol, valencene, eudesm-7(11)-en-4-ol, beta-caryophyllene, limonene, and myrcene.

5. Nuts produced by using the formulation of claim 4, being shelled kana pecan halves at a weight of at least about 0.8 to 1.7 lbs.

6. Nuts produced by using the formulation of claim 4, being at least one selected of the group of almonds, walnuts, cashews, pistachios, pine nuts, filberts, peanuts, macadamia nuts, brazil nuts and the like chimeric or synthetic versions combining the same.

7. Nuts produced by using the formulation of claim 4, the Cannabis-based and derived moiety being a least one of between at least about 0.8 g to 3.8 grams of specified cannabinoids.

8. The process of claim 1, wherein at least an egg, or related confectionary or baking element is included.

9. The process of claim 8, further comprising predetermined amounts of at least one of cinnamon, vanilla extract, and the like confectionary seasoning elements.

10. The process of claim 9, further comprising, in combination: mixing, 250 degree over placement and greasing, mixing again, coating and mixing before spreading on baking sheet and one hour in oven.

11. The process of claim 10, wherein a resultory composition comprising a cannabinoid extract or resin further comprises an emulsifier, and wherein the composition is a paste used with nuts or other foodstuffs; and,
wherein the composition comprising a cannabinoid extract or resin further comprises saponin emulsifier, and wherein the composition is a paste, effective for coating nuts or other foodstuffs.

12. A process for preparing a composition that comprises a plurality of coated nuts, the method comprising the steps of:
(i) Placing a plurality of nuts in a container, wherein the container comprises a bottom and a retaining wall or sides,
wherein the plurality of nuts in the container is capable of receiving and supporting an added cannabinoid extract or resin and the plurality of edible nuts is capable of substantially preventing contact of the cannabinoid extract or resin with the bottom of the container and is also capable of substantially preventing contact of the cannabinoid extract or resin with the retaining wall or sides,
(ii) Placing a cannabinoid extract or resin on top of the plurality of edible particles,
wherein the cannabinoid extract or resin does not substantially contact the bottom of the container, and does not substantially contact the retaining wall or sides of the container, and;
(iii) Mixing until the cannabinoid extract or resin coats the edible particles to produce a
coating, resulting in a composition of homogeneously coated edible particles, and wherein the homogeneously coated edible particles possess a homogeneity.

13. The process of claim 12, further comprising the step of initiating device mediated mixing of the cannabinoid extract or resin with the plurality of edible particles using a mixer, wherein the mixing generates a mixture, admixture, slurry or suspension.

14. The process of claim 13, wherein at the step where the cannabinoid extract or resin is placed on top of the plurality of edible particles, less than 10% of the extract or resin at this step contacts the bottom of the container, retaining wall, or sides.

15. The process of claim 14, wherein the homogeneously coated particles have an index of homogeneity, and where the homogeneity is definable by the range of values for specific surface area, in a given sample of at least 1000 coated particles.

16. The process of claim 15, wherein the container is an integral part of a mixer.

17. The process of claim 16, wherein the container is not an integral part of a mixer.

18. The process of claim 17, wherein the container has one or more internal sides and wherein the one or more internal sides of the container comprises discrete retaining walls, discrete sides, or a tubular retaining wall, wherein the device mediated mixing is with at least one of a dual asymmetrical centrifuge (DAC) mixer; ribbon blender; kitchen blender; V-type blender, double cone blender, fluidized bed mixer, or mass mixer, or with any combination thereof, effective to produce a dry instant powder for use in adding to or mixing with water and making a Cannabis-infused or medicated nut mix.

19. A kit, comprising, in combination:
at least a set of nuts comprising the formulation of claim 4;
said nuts being at least one of coated with, infused with, or otherwise combined with optional flavoring and/or other admixture; and optionally
another package comprised of a larger aliquot of nuts; and,
Directions for use.

20. A nut butter according to the formulation of claim 4.
